(19) United States
(12) Patent Application Publication
(10) Pub. No.: US 2009/0111442 A1
(43) Pub. Date: Apr. 30, 2009

(54) System and Method for Playing User-Defined Ring Tones Over a Cellular Telephone Headset

(75) Inventors: Bruce Barnes, Crystal Lake, IL (US); Shadi Khoshaba, Skokie, IL (US); Dolores Mallain, St. Charles, IL (US)

Correspondence Address: AT&T Legal Department - LNAP;Attn: Patent Docketing, Room 2A- 207, One AT & T Way, Bedminster, NJ, 07921, US

(73) Assignee: AT&T KNOWLEDGE VENTURES, LP, Reno, NV (US)

(21) Appl. No.: 11/932,025

(22) Filed: Oct. 31, 2007

(51) Int. Cl. H04M 3/42

(52) U.S. Cl. 455/415

(57) ABSTRACT

A caller identification system comprises a headset and a mobile communication device. The headset is operably configured to play a ring tone caller identification to a user. The mobile communication device is operably configured to send the ring tone caller identification to the headset upon a determination that the headset is in communication with the mobile communication device.

### FIELD OF THE DISCLOSURE

The present disclosure generally relates to caller identification, and more particularly relates to playing user-defined ring tones over a cellular telephone headset.

### BACKGROUND

Incoming caller identification, a feature that displays the caller's number for incoming calls to a called customer, allows selective acceptance of certain calls based on the calling number while other calls are either not answered or are routed to a message center. The feature is implemented by transmitting the calling line identification to the called customer landline telephone or cellular telephone in a data message. The data message is displayed by the landline telephone or cellular telephone in a text format for the customer. Because customers typically remember only a few, frequently called telephone numbers, a feature that additionally provides the caller name is substantially more useful to customers in deciding whether to accept a call.

In a call announcement arrangement which is the subject of U.S. Pat. No. 4,899,358, the calling party name is obtained from a database search and a text-to-speech unit generates speech signals, rather than a data message, for transmission to the called landline telephone. The calling party name is spoken at the landline telephone instead of being displayed. For a conventional analog landline telephone, the name is spoken after the called party has answered in response to ringing at the landline telephone but before a connection is completed to the caller.

### BRIEF DESCRIPTION OF THE DRAWINGS

FIG. 1 is a block diagram of a caller identification system;

FIG. 2 is a flow chart of a method for providing user-defined ring tones through a headset of a mobile communication device; and

FIG. 3 is a block diagram of a data processing device.

### DETAILED DESCRIPTION OF THE DRAWINGS

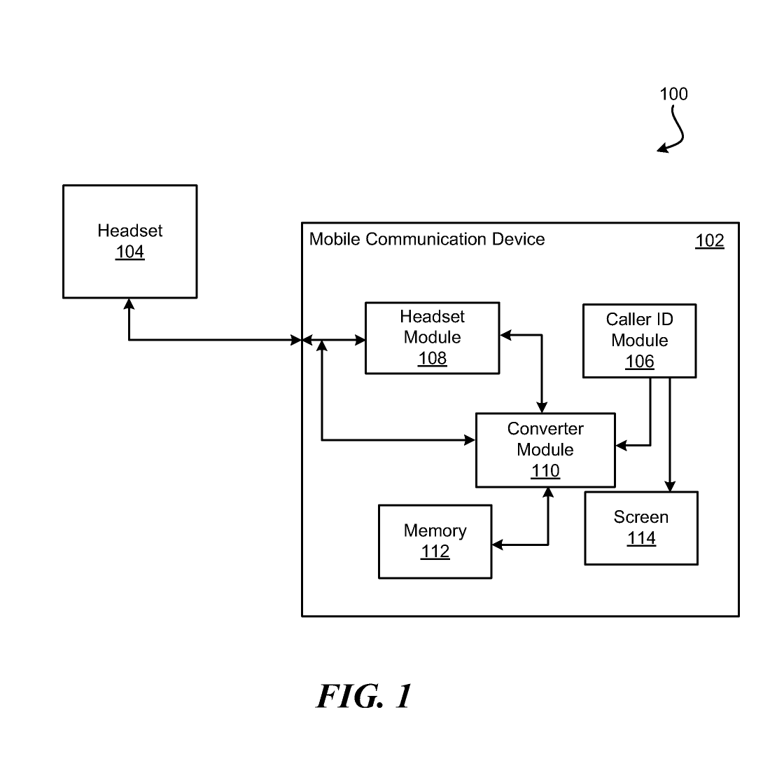

FIG. 1 shows a block diagram of a caller identification system 100 including a mobile communication device 102 and a headset 104. The mobile communication device 102 is preferably a cellular telephone, or any other portable device, having an associated telephone number. The mobile communication device 102 includes a caller identification module 106, a headset module 108, a converter module 110, and a memory 112. The headset 104 is preferably an earpiece worn by a user, a hands free vehicle communication system, or any other device capable of connecting with the mobile communication device 102. The mobile communication device 102 and the headset 104 communicate through a physical connection, or more preferably through a wireless connection such as an IEEE 802.11a/b/g compatible wireless fidelity (WiFi) connection or a wireless Bluetooth connection.

If the headset module 108 detects that the mobile communication device 102 is connected to the headset 104, the headset module sends an activation signal to the converter module 110. When the mobile communication device 102 receives an incoming telephone call, the caller identification module 106 extracts caller identification information such as the telephone number and/or the caller's name associated with the call. Regardless of whether the headset 104 is present, the caller identification module 106 preferably displays the caller identification information in a text format on a screen 114. If the converter module 110 is activated, however, it compares the calling party name and/or telephone number against a list of names and/or telephone numbers previously stored by the user in a directory in the memory 112.

If there is an exact (or, if desired, a close) match to one of the names or telephone numbers stored in the memory 112, the converter module 110 retrieves a ring tone previously associated by the user with the name and/or telephone number in the memory 112. The ring tones may be standard ones preloaded by the handset manufacturer, or more customized ones downloaded from, for example, cellular service providers over the Internet, as is well known. In an embodiment, incoming callers that cannot be associated with an entry in the directory may be assigned a default tone to distinguish them as unknown callers.

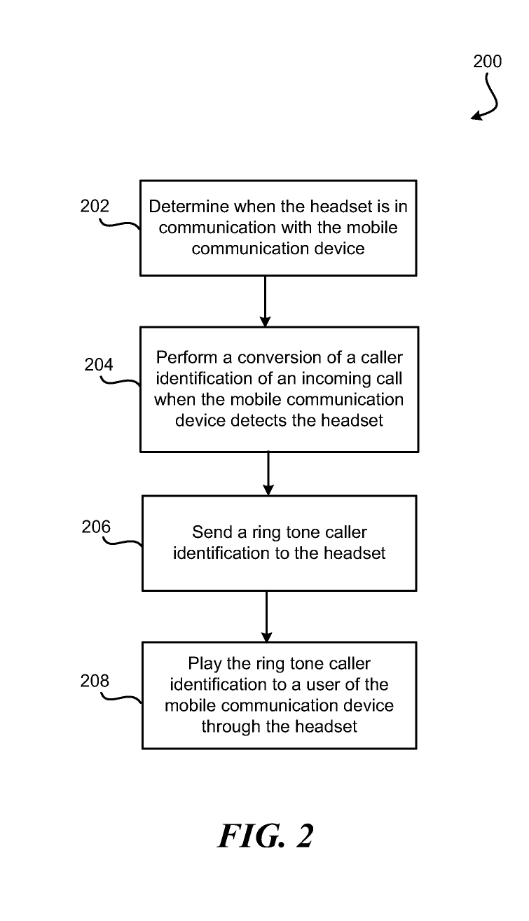

The converter module 110 then outputs the ring tone to the headset 104. All of these steps may be completed before the user answers the incoming telephone call. FIG. 2 shows a flow chart of a method 200 for providing ring tone caller identification through a headset of a mobile communication device. At block 202, the mobile communication device determines if the headset is in communication with the mobile communication device. The mobile communication device performs a conversion on a caller identification for an incoming telephone call when the headset is in communication with the mobile communication at block 204. At block 206, the mobile communication device sends a ring tone caller identification to the headset. The caller identification is sent through a wireless or a physical connection. The headset plays the ring tone caller identification to a user of the mobile communication at block 208.

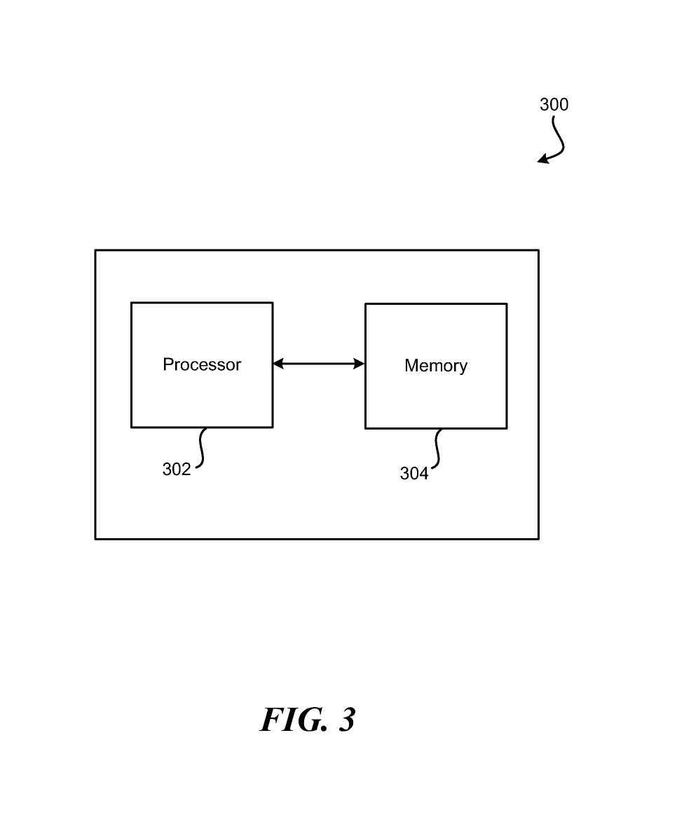

FIG. 3 shows a block diagram of a data processing device 300 comprising a processor 302 and a computer-readable medium such as a memory 304. The memory 304 stores a set of instructions to manipulate the processor to perform the method 200 of FIG. 2 above. In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosed subject matter is considered to include any one or more of a computer-readable medium or a distribution medium and other equivalents and successor media, in which data or instructions may be stored.

The ring tone caller identification system 100 thus provides the user with a number of advantages. One advantage is that the user is able to determine the identity of the caller without having to look at a display screen of the mobile communication device. This ability allows the user to receive the ring tone caller identification while in proximity to, but not actually holding, the mobile communication device 102. Also, if the user is driving a vehicle or carrying the mobile communication device 102 under clothing, in a pocket, or in a purse, then the user does not have to search for the mobile communication device to determine the caller identification of the incoming call.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A caller identification system comprising:
a headset operably configured to play a ring tone caller identification to a user; and
a mobile communication device operably configured to send the ring tone caller identification to the headset upon a determination that the headset is in communication with the mobile communication device.

2. The caller identification system of claim 1 wherein the mobile communication device includes:
a headset module operably configured to determine when the headset is in communication with the mobile communication device; and
a converter module in communication with the headset module, the converter module operably configured to perform a conversion for a caller identification of an incoming telephone call and to send a ring tone caller identification to the headset when the headset is in communication with the mobile communication device.

3. The caller identification system of claim 1 wherein the communication between the headset and the mobile communication device is through a wireless connection.

4. The caller identification system of claim 1 wherein the communication between the headset and the mobile communication device is through a physical connection.

5. The caller identification system of claim 1 wherein the headset is an earpiece.

6. The caller identification system of claim 1 wherein the headset is a hands free vehicle communication system.

7. A method for providing caller identification through a headset of a mobile communication device, the method comprising:
determining when the headset is in communication with the mobile communication device;
performing a conversion on a caller identification of an incoming telephone call when the headset is in communication with the mobile communication device;
sending a ring tone caller identification to the headset; and
playing the ring tone caller identification to a user of the mobile communication device through the headset.

8. The method of claim 7 wherein the headset is in communication with the mobile communication device through a wireless connection.

9. The method of claim 7 wherein the headset is in communication with the mobile communication device through a physical connection.

10. The method of claim 7 wherein the headset is an earpiece.

11. The method of claim 7 wherein the headset is a hands free vehicle communication system.

12. The method of claim 7 wherein the ring tone caller identification information is received from a phone book list in a memory of the mobile communication device.

13. A mobile communication device for providing a ring tone caller identification to a user, the mobile communication device comprising:
a headset module operably configured to determine when a headset is in communication with the mobile communication device; and
a converter module in communication with the headset module, the converter module operably configured to perform a conversion for a caller identification for an incoming telephone call and to send the ring tone caller identification to the headset when the headset is in communication with the mobile communication device.

14. The mobile communication device of claim 13 further comprising:
a caller identification module in communication with the converter module, the caller identification module operably configured to receive the caller identification for the incoming telephone call and to send the ring tone caller identification to the converter module; and
a memory connected to the converter module, the memory operably configured to store for access by the converter module.

15. The mobile communication device of claim 13 wherein the ring tone caller identification is an MP3 file.

16. The mobile communication device of claim 13 wherein the communication with the headset is through a wireless connection.

17. The mobile communication device of claim 13 wherein the communication with the headset is through a physical connection.

18. The mobile communication device of claim 13 wherein the headset is an earpiece.

19. The mobile communication device of claim 13 wherein the headset is a hands free vehicle communication system.

20. A telephone comprising:
a module adapted to associate caller identification information with a ring tone, to recognize when a headset is in communication with the telephone, and to output the ring tone to the headset when the headset is in communication with the telephone.

21. The telephone of claim 20 further comprising a memory in communication with the module, the memory having a directory of the caller identification information.

22. The telephone of claim 20 wherein the headset is a wireless headset.

23. The telephone of claim 20 wherein the telephone is a cellular telephone.
